(19) United States
(12) Patent Application Publication
(10) Pub. No.: US 2026/0184900 A1
(43) Pub. Date: Jul. 2, 2026

(54) BIO-BASED POLYVINYL CHLORIDE (PVC) GLOVES AND METHODS FOR THEIR PREPARATION

(71) Applicant: Precious Mountain Ent. Corp., Tortola (VG)

(72) Inventor: HSUN HUI LIN HUANG, Taipei (TW)

(21) Appl. No.: 19/006,383

(22) Filed: Dec. 31, 2024

(51) Int. Cl. C08K 13/02; B29B 13/00; B29C 41/00; B29C 41/14; B29C 41/46; B29K 27/06; B29K 105/00; B29L 31/48; C08K 3/22; C08K 5/01; C08K 5/098; C08K 5/103; C08K 5/11; C08K 5/12

(52) U.S. Cl. CPC C08K 13/02; B29B 13/00; B29C 41/003; B29C 41/14; B29C 41/46; B29K 2027/06; B29K 2105/0032; B29K 2105/0038; B29K 2105/0044; B29K 2995/0077; B29K 2995/0097; B29L 2031/4864; C08K 2003/2241; C08K 5/01; C08K 5/098; C08K 5/103; C08K 5/11; C08K 5/12; C08K 2201/014

(57) ABSTRACT

A glove dipping solution and a method for preparing bio-based gloves are provided. The gloves maintain desirable mechanical properties while incorporating a high proportion of bio-based plasticizers. The glove dipping solution comprises polyvinyl chloride, one or more selected bio-based plasticizers chosen from bio-succinic acid, bio-sebacic acid, laurate esters, glycerol tristearate, diethylene glycol laurate, dodecyl laurate, dibutyl laurate, propylene glycol diacetate, sorbitol diacetate, succinic diacetate, diethylhexyl succinate, epoxidized soybean oil, 1,2-epoxy-3-propyl-1,2,3-triestearoyl glycerol, and 1,3-epoxy-2-propyl-1,2,3-triestearoyl glycerol. The bio-based plasticizer content ranges from 25 weight percent to 41 weight percent of the total weight of the glove dipping solution, excluding volatile solvents. The solution includes one or more functional auxiliary materials such as plasticizers, stabilizers, thickeners, and opacifiers. The invention also provides bio-based gloves produced from this dipping solution, which exhibit tensile breaking strengths exceeding 7 MPa, elongation at break rates over 300%, and palm thicknesses ranging from 0.03 millimeters to 0.2 millimeters.

### FIELD OF THE INVENTION

The present invention relates to bio-based polyvinyl chloride (PVC) gloves, specifically gloves that incorporate bio-based plasticizers as components of their formulation. Furthermore, the invention pertains to methods for preparing glove dipping solutions and the resulting gloves, which achieve environmentally friendly material usage while maintaining desirable mechanical properties such as tensile strength and extensibility.

### BACKGROUND OF THE INVENTION

Currently, the majority of disposable gloves available in the market are manufactured from polyvinyl chloride (PVC), widely used across various industries including medical, food, and industrial sectors. Traditionally, these gloves rely on synthetic plasticizers, such as phthalates or terephthalates, to enhance their flexibility and workability. While these synthetic plasticizers effectively improve the mechanical properties of PVC gloves, they also raise significant environmental concerns. Specifically, many synthetic plasticizers are non-biodegradable and their usage can lead to environmental pollution, thereby prompting sustainability-related apprehensions.

Introducing bio-based plasticizers into PVC formulations has emerged as a potential solution to address these environmental issues. Bio-based plasticizers are derived from renewable resources, offering improved environmental compatibility and reducing reliance on fossil fuel-based materials. However, a major challenge in utilizing bio-based plasticizers lies in their impact on the mechanical performance of the gloves. Increasing the proportion of bio-based plasticizers in the glove formulation typically results in decreased tensile strength, reduced extensibility, and accelerated aging, rendering such gloves less durable compared to traditional industrial-grade gloves.

Moreover, although some existing formulations attempt to balance the use of bio-based materials with mechanical performance, they generally incorporate only small amounts of bio-based plasticizers and often blend them with synthetic plasticizers, thereby limiting their environmental benefits.

There remains a demand for PVC gloves that can incorporate a higher proportion of bio-based plasticizers without compromising critical mechanical properties such as tensile strength, extensibility, and durability. Specifically, there is a need for environmentally friendly gloves containing significant amounts of bio-based plasticizers that can maintain performance comparable to gloves formulated with synthetic plasticizers.

The present invention addresses this need by providing a glove dipping solution containing 25 weight percent to 41 weight percent bio-based plasticizers. Despite the high proportion of bio-based components, these gloves retain essential mechanical properties, making them suitable for a variety of applications including medical, industrial, and food processing. Additionally, the invention offers a method for preparing these bio-based gloves that enables efficient manufacturing while balancing environmental sustainability with product performance.

### SUMMARY OF THE INVENTION

The present invention provides a glove dipping solution and a method for its preparation, wherein the gloves contain a high proportion of bio-based plasticizers while maintaining desirable mechanical properties such as tensile strength, extensibility, and durability. Specifically, the invention involves a glove dipping solution comprising 25 weight percent to 41 weight percent bio-based plasticizers, enabling the production of environmentally friendly gloves suitable for various application scenarios.

In one aspect, the invention provides a glove dipping solution comprising polyvinyl chloride (PVC), one or more bio-based plasticizers, a volatile solvent, and one or more functional auxiliary materials. The bio-based plasticizers are selected from the following combination: bio-succinic acid, bio-sebacic acid, laurate esters, glycerol tristearate, diethylene glycol laurate, dodecyl laurate, dibutyl laurate, propylene glycol diacetate, sorbitol diacetate, succinic diacetate, diethylhexyl succinate, epoxidized soybean oil, 1,2-epoxy-3-propyl-1,2,3-triestearoyl glycerol, and 1,3-epoxy-2-propyl-1,2,3-triestearoyl glycerol. Excluding volatile solvents, the bio-based plasticizer content ranges from 25 weight percent to 41 weight percent of the total weight of the glove dipping solution. Functional auxiliary materials may include synthetic plasticizers, stabilizers, thickeners, and opacifiers.

In another aspect, the invention provides bio-based gloves manufactured from the glove dipping solution. These gloves comprise PVC, one or more bio-based plasticizers, and functional auxiliary materials, with the bio-based plasticizer content ranging from 25 weight percent to 41 weight percent of the total glove weight. The bio-based gloves exhibit excellent mechanical properties, including tensile breaking strengths exceeding 7 MPa, elongation at break rates over 300%, and palm thicknesses ranging from 0.03 millimeters to 0.2 millimeters. These properties render the gloves suitable for industrial, medical, food processing, and other general applications.

In a further aspect, the invention provides a method for preparing the glove dipping solution. The method includes providing a glove dipping solution comprising PVC, one or more bio-based plasticizers, a volatile solvent, and one or more functional auxiliary materials. The bio-based plasticizers are mixed at 25 weight percent to 41 weight percent of the total weight of the glove dipping solution, excluding volatile solvents. The glove dipping solution is then thoroughly mixed to achieve uniformity, followed by vacuum degassing.

Finally, glove molds are immersed in the dipping solution and heated to produce the gloves. This process enables efficient manufacturing of bio-based gloves while maintaining their mechanical performance.

The invention overcomes the limitations of traditional PVC gloves by using higher proportions of bio-based plasticizers without compromising mechanical properties. By combining bio-based plasticizers such as propylene glycol diacetate and laurate esters with PVC and functional auxiliary materials, the resulting bio-based gloves retain flexibility, strength, and durability even during prolonged use, without relying on or requiring minimal amounts of synthetic plasticizers. Additionally, the invention balances biodegradability with mechanical performance, meeting the growing market demand for sustainable products.

Gloves manufactured according to the present invention comply with international standards, including ASTM D 5250-19, and are suitable for various environments such as medical facilities, food processing, electronics manufacturing, and general industrial applications.

Generally, the bio-based content of PVC bio-based gloves can be less than 10%. However, the core innovation of this invention lies in successfully manufacturing PVC bio-based gloves with a bio-based content of 25% to 41%. This technology significantly increases the proportion of bio-based materials while maintaining stable product performance, providing a high-value-added solution to meet sustainability and environmental demands.

### BRIEF DESCRIPTION OF THE DRAWINGS

The objects, spirits, and advantages of the preferred embodiments of the present disclosure will be readily understood by the accompanying drawings and detailed descriptions, wherein:

FIG. 1 illustrates a flowchart of the glove dipping solution preparation process.

FIG. 2 illustrates a flowchart of the bio-based glove molding process.

### DESCRIPTION OF THE PREFERRED EMBODIMENTS

The present invention relates to bio-based polyvinyl chloride (PVC) gloves, particularly gloves that incorporate bio-based plasticizers as part of their formulation. Additionally, the invention encompasses methods for preparing bio-based gloves using a glove dipping solution. Specifically, the invention addresses the growing market demand for environmentally friendly materials by utilizing bio-based plasticizers, while overcoming the challenges associated with maintaining mechanical properties such as tensile strength, extensibility, and durability.

Conventional PVC gloves typically rely on synthetic plasticizers, such as phthalates and terephthalates, to impart flexibility and workability to the material. Although these synthetic plasticizers are effective, their non-biodegradable nature and potential health risks present environmentally related concerns. To address these issues, attempts have been made to introduce bio-based plasticizers derived from renewable resources. However, traditionally, the high proportion usage of bio-based plasticizers has often resulted in reduced mechanical performance, ultimately making the gloves less durable and more prone to wear and degradation.

The present invention overcomes these limitations by providing a glove dipping solution containing a high proportion (25 weight percent to 41 weight percent) of bio-based plasticizers, while ensuring that bio-based gloves prepared from this dipping solution retain essential mechanical properties. Furthermore, the invention provides a controlled manufacturing process for producing these bio-based gloves, ensuring product consistency and quality. Gloves manufactured according to this method are suitable for a variety of applications, including industrial, medical, food processing, and general purposes, offering an environmentally friendly alternative to traditional synthetic plasticizer-based gloves.

Polyvinyl chloride is a widely used thermoplastic material known for its versatility, durability, and cost-effectiveness. In the field of glove production, PVC offers excellent barrier protection, flexibility, and chemical resistance, making it an ideal choice for medical, food processing, and general industrial applications. PVC is commonly used in conjunction with plasticizers to enhance its flexibility and reduce brittleness. In one embodiment of the present invention, PVC serves as the base material for the glove dipping solution. Due to its inherent flexibility and compatibility with plasticizers, PVC is well-suited for use with bio-based plasticizers, allowing the gloves to maintain critical mechanical properties such as tensile strength and extensibility even with a high proportion of bio-based materials.

Another feature of the present invention is the use of bio-based plasticizers derived from renewable resources. Compared to traditional synthetic plasticizers like phthalates or terephthalates, these bio-based plasticizers are more environmentally friendly due to the former's non-biodegradability and potential health risks. The bio-based plasticizers used in the present invention are selected from the following combination: bio-based succinic acid, bio-based sebacic acid, laurate esters, glycerol tristearate, diethylene glycol laurate, dodecyl laurate, dibutyl laurate, propylene glycol diacetate, sorbitol diacetate, succinic diacetate, diethylhexyl succinate, epoxidized soybean oil, 1,2-epoxy-3-propyl-1,2,3-triestearoyl glycerol, and 1,3-epoxy-2-propyl-1,2,3-triestearoyl glycerol. These plasticizers are present in the glove dipping solution at concentrations ranging from 25 weight percent to 41 weight percent. It is important to note that the weight percentages mentioned herein are calculated excluding the weight of volatile solvents. This is because, in the manufacturing process of the bio-based gloves in this embodiment, volatile solvents evaporate and do not remain in the final product, thus they are excluded from the weight percentage calculations.

A significant challenge in using bio-based plasticizers is maintaining the mechanical properties of the gloves, such as flexibility, tensile strength, and extensibility. Typically, higher concentrations of bio-based plasticizers adversely affect these properties. However, the bio-based plasticizers selected in this embodiment effectively interact with the PVC matrix, enabling the bio-based gloves to retain essential mechanical properties even with a high proportion of bio-based materials. This represents a substantial advancement over existing technologies that rely on low proportions of bio-based plasticizers or combinations with synthetic plasticizers.

In addition to PVC and bio-based plasticizers, the glove dipping solution includes one or more functional auxiliary materials. These auxiliary materials are crucial for enhancing glove performance and ensuring compliance with industry standards. The functional auxiliary materials may include:
1. Plasticizers: Selected from phthalates, terephthalates, and polyesters, further enhancing the flexibility and workability of the gloves.
2. Stabilizers: Such as calcium soaps and zinc soaps, which improve the thermal stability and oxidation resistance of the gloves, preventing degradation during processing and use.
3. Thickeners: Isomerated alkanes and 2,2,4-trimethyl-1,3-pentanediol isobutyrate are used as thickeners to adjust the viscosity of the dipping solution, ensuring uniform glove formation during the dipping process.
4. Opacifiers: Specifically, titanium dioxide with purity exceeding 93%, used as an opacifier to improve the appearance and opacity of the gloves.

Each of these auxiliary materials plays a critical role in the overall performance of the glove dipping solution. For example, plasticizers enhance the flexibility of the gloves, stabilizers ensure durability under thermal and environmental stresses, thickeners regulate the viscosity of the dipping solution for consistent glove formation, and opacifiers provide aesthetic and functional benefits.

Besides the aforementioned components, the glove dipping solution also contains a volatile solvent. Although the volatile solvent does not remain in the final product (i.e., the bio-based gloves), it plays a vital role in the formulation and application of the dipping solution during the manufacturing process. For instance, volatile solvents help adjust the viscosity of the dipping solution to ensure it remains fluid and can be uniformly applied to the glove molds during dipping. Without volatile solvents, the dipping solution might become too viscous or uneven, leading to coating inconsistencies and defects in the final gloves. Additionally, once the gloves are formed on the molds, the volatile solvent evaporates during the drying and curing stages, ensuring that only the desired components (PVC, plasticizers, and auxiliary materials) remain in the final product. The concentration of volatile solvents is set within a range that allows effective dissolution of the components and facilitates easy evaporation during glove curing.

In this embodiment, the volatile solvent is typically a de-aromatized hydrocarbon solvent. De-aromatized hydrocarbon solvents are chosen for their low toxicity, minimal odor, and ability to evaporate cleanly without leaving harmful residues. These solvents are favored in this formulation because they strike a balance between effective solubilizing power and environmental and workplace safety. Furthermore, they reduce the risk of contamination in sensitive applications such as food processing or medical environments.

The formulation of the bio-based glove dipping solution is meticulously adjusted through the use of multiple experimental groups and control groups to achieve the desired mechanical properties while balancing the proportion of bio-based plasticizers to ensure environmental sustainability and performance. Key components of the glove dipping solution include PVC, bio-based plasticizers, synthetic plasticizers, stabilizers, thickeners, and volatile solvents.

Refer to Table 1, which illustrates the experimental and control groups used in this embodiment. The inventors prepared various experimental formulations to evaluate the performance of the glove dipping solution. These formulations varied the proportions of bio-based and synthetic plasticizers to test their effects on flexibility, strength, and aging resistance. In each formulation, PVC serves as the primary polymer matrix, while bio-based plasticizers contribute to enhanced flexibility and environmental friendliness.

TABLE 1

| | | | Calcium | Aromatic | | |
|---|---|---|---|---|---|---|
| Experimental | PVC | Dioctyl | Zinc | Hydrocarbon | bio-based | |
| Number | Powder | Terephthalate | Stabilizer | Solvent | plasticizers | Ratio |
| TP-917B-2 | 100 | — | 2 | 25 | 70 | 0.41 |
| TP-917B-3 | 100 | 70 | 2 | 25 | — | 0 |
| TP-917B-5 | 100 | 23.3 | 2 | 25 | 46.7 | 0.27 |
| TP-917B-6 | 100 | 46.7 | 2 | 25 | 23.3 | 0.135 |
| TP-917B-7 | 100 | 17.5 | 2 | 25 | 52.5 | 0.31 |

### Description of Experimental and Control Groups

1. Control Group (TP-917B-3): This group does not contain any bio-based plasticizers. It comprises PVC, synthetic plasticizers (specifically di-octyl phthalate), stabilizers, thickeners, and volatile aromatic hydrocarbon solvents. This group serves as a baseline comparison, representing a traditional glove formulation without any bio-based materials.
2. Experimental Groups:
   TP-917B-2: This group includes PVC, a high proportion of bio-based plasticizers (70 kg), synthetic plasticizers, stabilizers, and volatile aromatic hydrocarbon solvents. The bio-based plasticizers account for 41% of the formulation (excluding solvents), representing the upper limit of the desired bio-based plasticizer content.
   TP-917B-5: In this group, the concentration of bio-based plasticizers is 27% of the total formulation (46.7 kg). Compared to the control group, the usage of synthetic plasticizers is reduced. The overall objective of this group is to test the balance between performance and sustainability while maintaining a moderate level of bio-based content.
   TP-917B-6: This group contains a lower concentration of bio-based plasticizers, accounting for 13.5% of the total formulation, while retaining a portion of synthetic plasticizers. The volatile solvents and other auxiliary materials are consistent with those in other experimental groups.
   TP-917B-7: This group has a bio-based plasticizer concentration of 31%, representing a mid-range formulation aimed at exploring whether a slightly higher proportion of bio-based materials can achieve the necessary mechanical properties while maintaining durability and flexibility.

All experimental formulations include volatile aromatic hydrocarbon solvents, which facilitate the processing and coating of glove molds. During the curing process, the solvents evaporate, leaving behind the final polymer structure composed of PVC, plasticizers, and auxiliary materials.

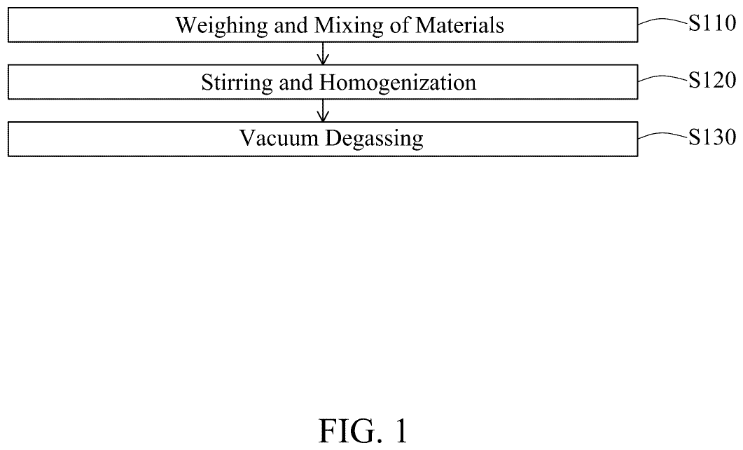

Refer to FIG. 1, which illustrates a flowchart of the glove dipping solution preparation process. The following is a step-by-step detailed explanation of the preparation process.

### Step S110: Weighing and Mixing of Materials

Initially, as depicted in Step S110, the materials required for the glove dipping solution are accurately weighed and mixed. In this step, the necessary materials for the glove dipping solution are precisely measured. These materials include polyvinyl chloride (PVC), at least one bio-based plasticizer, and selected functional auxiliary materials such as plasticizers, stabilizers, thickeners, and opacifiers. Based on the total weight of the glove dipping solution excluding volatile solvents, the amount of bio-based plasticizer is calculated to be between 25 weight percent and 41 weight percent.

### Step S120: Stirring and Homogenization

After weighing, as shown in Step S120, the materials undergo stirring and homogenization. These materials are added to a mixing tank and continuously stirred to ensure uniform distribution of all components. The bio-based plasticizer and auxiliary materials are thoroughly mixed with the PVC matrix, forming a consistent solution. Following the initial mixing of materials, the solution enters the stirring phase to achieve complete homogenization. This step ensures that all components are evenly distributed throughout the solution, which is essential for maintaining consistent mechanical properties of the gloves. The stirring process typically lasts for four to five hours to ensure that the bio-based plasticizer and auxiliary materials are fully dispersed. Additionally, during this step, thickeners (such as isomerated alkanes and 2,2,4-trimethyl-1,3-pentanediol isobutyrate) are carefully added to adjust the viscosity. These thickeners help control the flow characteristics of the solution, ensuring it has the optimal viscosity suitable for the glove dipping process. Controlling the viscosity is a critical factor in the preparation of the glove dipping solution, as it directly affects the quality of the manufactured gloves by influencing the thickness and uniformity of the glove layers. If the viscosity is too high, the gloves may become excessively thick and lose flexibility; if too low, the gloves may be too thin and prone to tearing.

### Step S130: Vacuum Degassing

Upon completion of the stirring phase, Step S130 involves vacuum degassing of the glove dipping solution. This step is performed to remove any bubbles that may have been introduced during the mixing process. Bubbles in the solution can lead to defects in the final gloves, such as weak points or surface imperfections. The degassing process involves placing the solution in a vacuum chamber and applying a vacuum. The solution remains in the vacuum chamber for typically 24 hours or longer. Extended degassing time allows all gases to be gradually removed, ensuring that the solution is fully degassed and ready for the next stage of glove formation.

Throughout the preparation process, it is essential to regularly monitor and adjust the viscosity to ensure that the solution remains within the optimal range for glove formation. This practice helps maintain consistency in the final product and ensures that each produced glove meets the required mechanical and dimensional specifications.

Temperature plays a crucial role in the preparation and handling of the glove dipping solution. Precise temperature control is maintained at each stage to ensure that the components are thoroughly mixed and appropriately reacted, and to ensure that the solution remains stable before and during the glove formation process. During the initial mixing stage, the temperature is maintained between 48° C. and 60° C. to facilitate the thorough mixing of PVC, bio-based plasticizer, and auxiliary materials. This temperature range ensures that the materials are sufficiently fluid for thorough mixing without overheating, which could cause degradation or unwanted reactions.

Refer to Table 2, which illustrates the experimental results of viscosity changes in the glove dipping solution for both experimental and control groups. The viscosity variation experiments provide valuable insights into the stability and performance of the glove dipping solution over time. Viscosity is a critical parameter in glove manufacturing as it affects coating uniformity, dipping ease, and the final performance of the gloves. The data from the experimental and control groups highlight the behavioral differences of various formulations, particularly in viscosity changes over a seven-day period.

TABLE 2
Viscosity (cps.)

| Experimental | Day | Day | Day | Day | Day | Day | Day | Viscosity Variation | |
|---|---|---|---|---|---|---|---|---|---|
| Number | 1 | 2 | 3 | 4 | 5 | 6 | 7 | Rate | |
| TP-917B-2 | 61 | 60 | | 57 | 60 | 64 | 64 | 0.428 | cps/day |
| TP-917B-3 | 60 | 59 | | 63 | 67 | 67 | 67 | 1 | cps/day |
| TP-917B-5 | 53 | 49 | 57 | 54 | 54 | 56 | | 0.5 | cps/day |
| TP-917B-6 | 56 | 55 | 55 | 62 | 55 | 62 | | 1 | cps/day |
| TP-917B-7 | 55 | 52 | 54 | 54 | 58 | 58 | | 0.5 | cps/day |

The control group (TP-917B-3), which does not contain any bio-based plasticizers, exhibited relatively stable viscosity. Its viscosity was 60 cps on Day 1 and increased steadily to 67 cps by Day 7. However, as shown in Table 2, this control group had the highest viscosity variation rate among all formulations, at 1 cps/day. This indicates that, although the initial viscosity of the control group was moderate, its viscosity increased rapidly over time, suggesting that formulations without bio-based plasticizers may be less stable or more prone to viscosity fluctuations compared to those containing bio-based plasticizers.

The experimental group TP-917B-2, containing the highest proportion of bio-based plasticizers (41% of the formulation), had an initial viscosity of 61 cps on Day 1. Over seven days, the viscosity gradually and consistently increased to 64 cps by Day 7, resulting in a viscosity variation rate of 0.428 cps/day. This demonstrates that a high proportion of bio-based plasticizers contributes to better viscosity stability, making it suitable for consistent glove production.

In the experimental group TP-917B-5, which contains a moderate proportion of bio-based plasticizers (31% of the formulation), the viscosity was 53 cps on Day 1 and increased steadily to 56 cps by Day 7, with a viscosity variation rate of 0.5 cps/day. Although the viscosity variation rate is slightly higher than that of TP-917B-2, the overall stability remains acceptable, indicating that a moderate proportion of bio-based plasticizers achieves a good balance between initial viscosity and long-term stability.

The experimental groups TP-917B-6 and TP-917B-7, containing lower proportions of bio-based plasticizers (19% and 34% of the formulation, respectively), exhibited similar viscosity variation trends. TP-917B-6 had a viscosity of 56 cps on Day 1, increasing to 62 cps by Day 7, while TP-917B-7 showed an increase from 55 cps on Day 1 to 58 cps by Day 7. Their viscosity variation rates were 1 cps/day and 0.5 cps/day, respectively. These results indicate that formulations with higher proportions of bio-based plasticizers demonstrate greater viscosity stability.

The data indicate that bio-based plasticizers contribute to enhanced viscosity stability of the glove dipping solution. Specifically, the experimental group TP-917B-2, with the highest proportion of bio-based plasticizers, exhibited the most stable viscosity change over seven days with the lowest variation rate. This suggests that bio-based plasticizers not only offer environmental benefits but also improve the ability of the formulation to maintain consistent viscosity over time, which is crucial for the manufacturing process.

In contrast, the control group (TP-917B-3) and experimental group TP-917B-6, which have lower or no bio-based plasticizer content, showed higher viscosity variation rates. This implies that the absence or low proportion of bio-based plasticizers leads to poorer formulation stability, resulting in viscosity fluctuations that can cause uneven coating during the glove dipping process and affect the final thickness and mechanical properties of the gloves.

Overall, the results demonstrate that the inclusion of bio-based plasticizers, particularly within the 31% to 41% concentration range, helps maintain a stable viscosity profile for the glove dipping solution. This stability is essential for large-scale, high-quality glove production, ensuring that the gloves meet the required mechanical and dimensional specifications consistently.

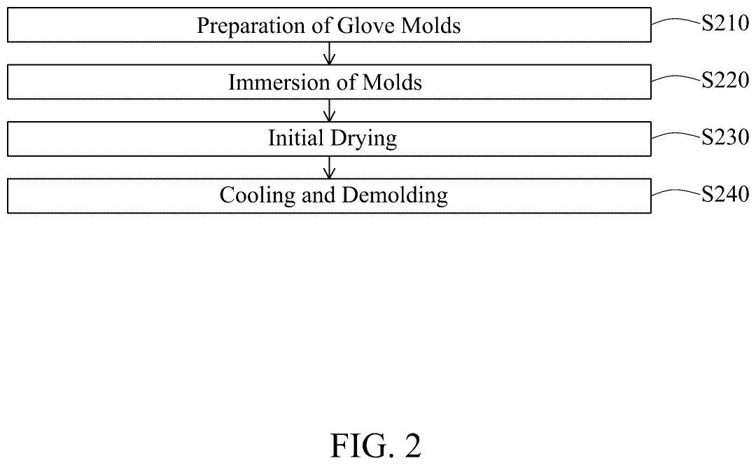

Refer to FIG. 2, which illustrates a flowchart of the bio-based glove molding process. The following is a step-by-step detailed explanation of the molding process.

### Step S210: Preparation of Glove Molds

Initially, as depicted in Step S210, the glove molds are prepared. Glove molds are typically made of ceramic or metal and must be cleaned and preheated before being immersed in the glove dipping solution. The preheating process is crucial to ensure proper adhesion of the solution to the mold surfaces. The molds are preheated to a temperature range of 65° C. to 85° C., which facilitates the uniform coating of the dipping solution during the immersion process.

### Step S220: Immersion of Molds

After preheating, as shown in Step S220, the molds are immersed in the glove dipping solution. The glove molds are transported along the production line and dipped into the glove dipping solution. During the immersion process, the solution adheres to the surface of the molds, forming a uniform coating. The temperature of the glove dipping solution is maintained between 48° C. and 60° C. to ensure optimal viscosity and consistent layer formation. The immersion process is precisely controlled to achieve the desired glove thickness. The depth and duration of immersion can be adjusted as needed to ensure that the palm thickness of the bio-based gloves ranges from 0.03 millimeters to 0.2 millimeters, ensuring that the bio-based gloves meet the specifications required for various applications.

After immersion, the molds are slowly withdrawn from the glove dipping solution, allowing excess material to drip off, thereby ensuring a smooth and even coating on the mold surfaces.

### Step S230: Initial Drying

Upon completion of the immersion process, as depicted in Step S230, the glove dipping solution undergoes initial drying. The coated glove molds are transferred to a drying station. At this stage, the gloves are subjected to controlled temperature drying to evaporate any solvents and to solidify the polymer matrix. After drying, the gloves undergo a curing process, which involves baking the gloves to fully harden the polymer structure and ensure that the gloves exhibit the desired mechanical properties. The curing process takes place in an oven at a temperature range of 160° C. to 230° C., depending on the dipping solution formulation and the performance requirements of the final product. The curing time typically ranges from 4 to 9 minutes, during which the bio-based plasticizers and auxiliary materials cross-link with the PVC matrix, resulting in the hardened gloves.

### Step S240: Cooling and Demolding

After curing, as shown in Step S240, the gloves are gradually cooled before being peeled off from the molds. The cooling process must prevent thermal shock to avoid weakening the bio-based gloves or causing surface defects. The bio-based gloves are cooled to room temperature to ensure they retain their mechanical integrity and aesthetic quality.

Once the gloves are molded, cured, and cooled, the production of the bio-based gloves is complete. The bio-based gloves manufactured by this method exhibit the following key performance characteristics:
1. Tensile Breaking Strength: The gloves have a tensile breaking strength exceeding 7 MPa, making them suitable for applications requiring high mechanical strength.
2. Elongation at Break: The gloves have an elongation at break exceeding 300%, providing excellent flexibility and resilience.
3. Palm Thickness: The palm thickness ranges from 0.03 millimeters to 0.2 millimeters, ensuring protective coverage while maintaining tactile sensitivity.

These combined mechanical properties ensure that the gloves are highly suitable for various applications, including medical, industrial, and food processing environments.

The bio-based gloves manufactured according to the present invention maintain excellent mechanical properties despite containing a high proportion of bio-based plasticizers. Refer to Table 3, which illustrates the test results of mechanical properties for both experimental and control groups.

TABLE 3
Properties Before and After Aging

| | | 180° C. × 8 | 190° C. × 8 | 200° C. × 8 | 180° C. × 8 | 200° C. × 8 | |
|---|---|---|---|---|---|---|---|
| Experimental | | (Before | Before | (Before | (After | (After | |
| Number | Properties | Aging) | Aging) | Aging) | Aging) | Aging) | Aging |
| TP-917B-2 | Tensile | 19.8 | 22.4 | 26.6 | 18.7 | 25.2 | No Oil |
| | breaking | | | | | | Exudation |
| | strength | | | | | | |
| | (MPa) | | | | | | |
| TP-917B-3 | Tensile | 21.0 | 20.8 | 22.4 | 20.5 | 22.7 | No Oil |
| | breaking | | | | | | Exudation |
| | strength | | | | | | |
| | (MPa) | | | | | | |
| TP-917B-2 | Elongation | 328 | 310 | 335 | 290 | 335 | — |
| | Rate | | | | | | |
| TP-917B-3 | Elongation | 351 | 324 | 345 | 323 | 356 | — |
| | Rate | | | | | | |
| TP-917B-2 | Color | White | White | Slightly | Slightly | Slightly | — |
| | | | | White | White | Yellow | |
| TP-917B-3 | Color | White | White | White | White | Slightly | — |
| | | | | | | White | |
| TP-917B-5 | Tensile | 21.9 | 24.5 | 26.6 | 24.1 | 24.8 | No Oil |
| | breaking | | | | | | Exudation |
| | strength | | | | | | |
| | (MPa) | | | | | | |
| TP-917B-6 | Tensile | 21.5 | 24.2 | 24.6 | 20.0 | 24.4 | No Oil |
| | breaking | | | | | | Exudation |
| | strength | | | | | | |
| | (MPa) | | | | | | |
| TP-917B-5 | Elongation | 369 | 361 | 313 | 388 | 322 | — |
| | Rate | | | | | | |
| TP-917B-6 | Elongation | 358 | 373 | 343 | 328 | 331 | — |
| | Rate | | | | | | |
| TP-917B-5 | Color | White | White | Slightly | White | Slightly | — |
| | | | | Yellow | | Yellow | |
| TP-917B-6 | Color | White | White | Slightly | White | Slightly | — |
| | | | | White | | Yellow | |
| TP-917B-7 | Tensile | 21.2 | 23.6 | 23.5 | 19.1 | 24.2 | No Oil |
| | breaking | | | | | | Exudation |
| | strength | | | | | | |
| | (MPa) | | | | | | |
| TP-917B-7 | Elongation | 358 | 323 | 340 | 325 | 350 | — |
| | Rate | | | | | | |
| TP-917B-7 | Color | White | White | Slightly | Slightly | Slightly | — |
| | | | | Yellow | White | Yellow | |

Under conditions of 180° C. for 8 minutes (i.e., immersing the gloves in an 180° C. environment for 8 minutes), the tensile breaking strength of TP-917B-2 (which contains the highest content of bio-based plasticizers) is 19.8 MPa, whereas the control group (TP-917B-3) shows a slightly higher tensile breaking strength of 21.0 MPa.

When the curing temperature is increased to 200° C. for 8 minutes, the tensile breaking strength of TP-917B-2 increases to 26.6 MPa, surpassing the control group's 22.4 MPa.

After the aging process, the tensile breaking strength of the gloves slightly decreases. Under curing conditions of 180° C. for 8 minutes, the tensile breaking strength of TP-917B-2 decreases to 18.7 MPa, while at 190° C. for 8 minutes, it remains at 22.8 MPa.

Similarly, the control group (TP-917B-3) exhibits tensile breaking strengths of 20.5 MPa (180° C.×8 minutes) and 20.6 MPa (190° C.×8 minutes) after aging, indicating that both formulations maintain strong tensile integrity post-aging.

These results demonstrate that although the control group initially exhibits slightly higher tensile strength, the gloves containing bio-based plasticizers (TP-917B-2) perform better under high-temperature curing conditions and maintain excellent tensile strength after aging.

Refer to Table 3, which presents the elongation at break (Elongation Rate) results.

### Elongation at Break (Before Aging):

Under curing conditions of 180° C. for 8 minutes, TP-917B-2 exhibits an elongation at break of 328%, while the control group (TP-917B-3) shows 351%.

At 200° C. for 8 minutes, TP-917B-2's elongation at break increases to 335%, and the control group reaches 345%.

### Elongation at Break (After Aging):

After aging, TP-917B-2 shows an elongation at break of 290% under curing conditions of 180° C. for 8 minutes and 311% at 190° C. for 8 minutes, indicating a slight decrease but still maintaining high flexibility.

The control group (TP-917B-3) displays slightly higher elongation rates after aging, with 323% (180° C.×8 minutes) and 344% (190° C.×8 minutes).

These results indicate that bio-based gloves retain excellent flexibility and extensibility even after the aging process. Although there is a slight decrease in elongation rates post-aging, the bio-based gloves of the present embodiment maintain sufficient flexibility, making them suitable for demanding work environments.

Additionally, refer to Table 3, which tracks the color and surface appearance changes of the bio-based gloves after aging. All experimental and control groups maintained their original color, typically white or slightly off-white, under lower curing temperatures (180° C. and 190° C.). However, at higher curing temperatures (200° C.×8 minutes), the gloves exhibited slight yellowing, which did not adversely affect their mechanical properties.

Furthermore, none of the experimental groups exhibited oil exudation (Oil Exudation) after the aging process. This indicates that bio-based plasticizers do not migrate to the glove surface over time, thereby preserving the structural integrity and appearance of the gloves. Oil exudation, a common issue in gloves with high plasticizer content, can lead to greasy surfaces, reduced performance, and overall diminished quality. In traditional formulations using synthetic plasticizers, plasticizers may leach out or migrate from the PVC matrix, resulting in oil exudation. However, the bio-based gloves produced according to the present invention do not exhibit significant oil exudation even after aging. This is attributed to the strong interaction between the bio-based plasticizers (such as propylene glycol diacetate and laurate esters) and the PVC matrix, forming stable bonds that prevent migration and ensure that the plasticizers remain embedded within the glove material over the long term.

It is important to note that the present invention relies on the use of bio-based plasticizers, rather than biomass fillers, to achieve the desired mechanical properties and environmental benefits of the PVC gloves. While various prior-art approaches have introduced biomass-derived materials into latex or PVC formulations, these are typically employed as fillers, stabilizers, or crosslinking system modifiers, rather than as primary agents for plasticization. For example, US20220380582A1 discloses certain compositions incorporating biomass fillers and sulfur-free crosslinking agents in latex and PVC-based gloves. However, in those references, the biomass materials do not serve as the principal means of imparting flexibility, elasticity, and tensile strength to the polymer matrix. Instead, they are generally added to affect properties such as environmental footprint, cost, or surface characteristics, or to replace certain traditional crosslinkers, without fundamentally changing the polymer's internal chain mobility in the same manner as plasticizers.

In contrast, the present invention focuses on integrating a relatively high proportion-ranging from about 25 weight percent to about 41 weight percent (excluding volatile solvents)—of carefully selected bio-based plasticizers into the PVC matrix. By doing so, the invention leverages the intrinsic compatibility and molecular-level interactions between these bio-based plasticizers and the PVC chains. Plasticizers, unlike fillers, are not merely dispersed throughout the polymer as inert particulates or reinforcing agents. Instead, they blend intimately and homogeneously with the PVC, thereby increasing the free volume within the polymer matrix and reducing intermolecular forces between PVC chains. This results in enhanced flexibility, decreased brittleness, and improved tensile and elongation properties. Such molecular-scale integration enables the gloves to achieve mechanical performance metrics comparable to or exceeding those of gloves relying on synthetic plasticizers, while simultaneously improving sustainability and environmental friendliness.

In essence, biomass fillers and other additive systems described in prior art, such as US20220380582A1, cannot directly replace the function of a plasticizer. Fillers lack the specific chemical and physical characteristics needed to interact at the polymer chain level and lower the glass transition temperature or enhance flexibility to the same extent as genuine plasticizers. Thus, while fillers may complement overall glove properties, their role remains distinct and non-overlapping with that of the bio-based plasticizers highlighted in the present invention. The clear focus of this invention is on substituting a significant portion of synthetic plasticizers with bio-based alternatives-rather than employing fillers—to strike the delicate balance of sustainability, mechanical robustness, and cost-effectiveness. This strategic approach yields PVC gloves that combine environmental responsibility with the high performance demanded in medical, industrial, and food-processing applications.

The present invention provides several enhancements over existing technologies:
1. High Bio-Based Content: The gloves maintain their mechanical properties even with the incorporation of 25 weight percent to 41 weight percent bio-based plasticizers, outperforming most existing formulations that use lower proportions. Additionally, these bio-based plasticizers are derived from renewable biological resources (e.g., plant oils) rather than petrochemical sources. Utilizing renewable raw materials reduces dependence on fossil fuels, lowers carbon emissions, and enables a more sustainable production process.
2. Mechanical Integrity: Despite the high proportion of bio-based materials, the gloves retain excellent tensile strength, extensibility, and surface performance, making them suitable for a wide range of applications.
3. Aging Resistance: The gloves exhibit durable performance after undergoing aging processes, maintaining mechanical properties comparable to or better than traditional gloves. This demonstrates superior aging resistance compared to conventional formulations.

In summary, the present invention offers an environmentally beneficial solution for industries seeking to reduce reliance on non-renewable resources and minimize environmental impact. By incorporating bio-based plasticizers, the gloves provide a sustainable alternative that not only addresses environmental concerns but also delivers high-performance products capable of meeting the demands of various industries.

What is claimed is:

1. A glove dipping solution comprising:
polyvinyl chloride;
a bio-based plasticizer selected from the group consisting of bio-succinic acid, bio-sebacic acid, laurate esters, glycerol tristearate, diethylene glycol laurate, dodecyl laurate, dibutyl laurate, propylene glycol diacetate, sorbitol diacetate, succinic diacetate, diethylhexyl succinate, epoxidized soybean oil, 1,2-epoxy-3-propyl-1,2,3-triestearoyl glycerol, and 1,3-epoxy-2-propyl-1,2,3-triestearoyl glycerol;
one or more functional auxiliary materials selected from stabilizers, thickeners, and opacifiers; and
a volatile solvent,
wherein the bio-based plasticizer is present in an amount of from 25 weight percent to 41 weight percent based on the total weight of the glove dipping solution excluding the volatile solvent.

2. The glove dipping solution of claim 1, wherein the bio-based plasticizer is propylene glycol diacetate.

3. The glove dipping solution of claim 1, wherein the functional auxiliary materials comprise a metal soap stabilizer selected from calcium soaps and zinc soaps, a thickener selected from isomerated alkanes and 2,2,4-trimethyl-1,3-pentanediol isobutyrate, and an opacifier comprising titanium dioxide.

4. The glove dipping solution of claim 3, further comprising a synthetic plasticizer selected from the group consisting of phthalates, terephthalates, and polyesters.

5. The glove dipping solution of claim 3, wherein the thickener comprises isomerated alkanes and 2,2,4-trimethyl-1,3-pentanediol isobutyrate.

6. The glove dipping solution of claim 1, wherein the volatile solvent is a de-aromatized hydrocarbon solvent.

7. The glove dipping solution of claim 1, wherein the bio-based plasticizer is present in an amount of from 31 weight percent to 41 weight percent based on the total weight of the glove dipping solution excluding the volatile solvent.

8. A bio-based glove composition comprising:
polyvinyl chloride;
a bio-based plasticizer selected from the group consisting of bio-succinic acid, bio-sebacic acid, laurate esters, glycerol tristearate, diethylene glycol laurate, dodecyl laurate, dibutyl laurate, propylene glycol diacetate, sorbitol diacetate, succinic diacetate, diethylhexyl succinate, epoxidized soybean oil, 1,2-epoxy-3-propyl-1,2,3-triestearoyl glycerol, and 1,3-epoxy-2-propyl-1,2,3-triestearoyl glycerol;
one or more functional auxiliary materials selected from stabilizers, thickeners, and opacifiers;
wherein the bio-based plasticizer is present in an amount of from 25 weight percent to 41 weight percent based on the total weight of the bio-based glove.

9. The bio-based glove composition of claim 8, wherein the bio-based plasticizer is propylene glycol diacetate.

10. The bio-based glove composition of claim 8, wherein the functional auxiliary materials comprise a metal soap stabilizer selected from calcium soaps and zinc soaps, a thickener selected from isomerated alkanes and 2,2,4-trimethyl-1,3-pentanediol isobutyrate, and an opacifier comprising titanium dioxide.

11. The bio-based glove composition of claim 8, further comprising a synthetic plasticizer selected from the group consisting of phthalates, terephthalates, and polyesters.

12. The bio-based glove composition of claim 8, wherein the bio-based glove exhibits the following mechanical properties:
a tensile breaking strength exceeding 7 MPa;
an elongation at break exceeding 300%; and
a palm thickness ranging from 0.03 millimeters to 0.2 millimeters.

13. The bio-based glove composition of claim 8, wherein the bio-based plasticizer is present in an amount of from 31 weight percent to 41 weight percent based on the total weight of the glove dipping solution excluding the volatile solvent.

14. A method for preparing a glove dipping solution, comprising the steps of:
providing a glove dipping solution comprising polyvinyl chloride (PVC), a bio-based plasticizer, a volatile solvent, and one or more functional auxiliary materials, wherein the bio-based plasticizer is present in an amount of from 25 weight percent to 41 weight percent based on the total weight of the glove dipping solution excluding the volatile solvent;
thoroughly mixing the glove dipping solution to achieve uniformity;
vacuum degassing the glove dipping solution; and
immersing a glove mold into the glove dipping solution and heating the glove mold to form a bio-based glove,
wherein the bio-based plasticizer is selected from the group consisting of bio-succinic acid, bio-sebacic acid, laurate esters, glycerol tristearate, diethylene glycol laurate, dodecyl laurate, dibutyl laurate, propylene glycol diacetate, sorbitol diacetate, succinic diacetate, diethylhexyl succinate, epoxidized soybean oil, 1,2-epoxy-3-propyl-1,2,3-triestearoyl glycerol, and 1,3-epoxy-2-propyl-1,2,3-triestearoyl glycerol;
wherein the functional auxiliary materials are selected from synthetic plasticizers, stabilizers, thickeners, opacifiers, and liquid nitrile rubber.

15. The method of claim 14, wherein the bio-based plasticizer is propylene glycol diacetate.

16. The method of claim 14, wherein the step of forming the bio-based glove includes preheating the glove mold to a temperature range of 65° C. to 85° C. before immersing it into the glove dipping solution.

17. The method of claim 14, further comprising baking the formed bio-based glove in an oven at a temperature range of 160° C. to 230° C. for a duration of 4 to 9 minutes.

18. The method of claim 14, wherein the stabilizer comprises metal soap stabilizers selected from calcium soaps and zinc soaps, and the opacifier comprises titanium dioxide with a purity exceeding 93%.

19. The method of claim 14, wherein the volatile solvent is a de-aromatized hydrocarbon solvent.

20. The method of claim 14, wherein the bio-based plasticizer is present in an amount of from 31 weight percent to 41 weight percent based on the total weight of the glove dipping solution excluding the volatile solvent.
